(19) United States
(12) Patent Application Publication
(10) Pub. No.: US 2026/0331534 A1
(43) Pub. Date: Oct. 22, 2026

(54) NOVEL-ARCHITECTURE ELECTRODES WITH ENHANCED MASS TRANSPORT FOR HIGH-EFFICIENCY AND LOW-COST HYDROGEN ENERGY

(71) Applicant: University of Tennessee Research Foundation, Knoxville, TN (US)

(72) Inventors: Feng Yuan Zhang, Knoxville, TN (US); Lei Ding, Knoxville, TN (US); Kui Li, Los Alamos, NM (US); Weitian Wang, Knoxville, TN (US); Shule Yu, Tullahoma, TN (US); Douglas Scott Aaron, Oak Ridge, TN (US); Matthew M. Mench, Knoxville, TN (US); Frida Helena Roenning, Knoxville, TN (US); Anirban Roy, Knoxville, TN (US)

(73) Assignee: University of Tennessee Research Foundation, Knoxville, TN (US)

(21) Appl. No.: 19/631,649

(22) Filed: Mar. 27, 2026

Related U.S. Application Data
(62) Division of application No. 17/717,821, filed on Apr. 11, 2022, now abandoned.
(60) Provisional application No. 63/233,531, filed on Aug. 16, 2021.

(51) Int. Cl. H01M 8/026; H01M 8/0232; H01M 8/0234; H01M 8/0265; H01M 8/1018

(52) U.S. Cl. CPC H01M 8/026; H01M 8/0232; H01M 8/0234; H01M 8/0265; H01M 8/1018

(57) ABSTRACT

The presently disclosed subject matter relates to devices, systems, and methods of producing an improved fluid flow assembly and liquid/gas diffusion layer in solid polymer electrolyte electrochemical cells. In one aspect, a fluid flow assembly for a polymer electrolyte water electrolyzer includes a flow field having an inlet, an outlet, and a plurality of discrete lands arranged within the flow field. A liquid/gas diffusion layer is positioned in communication with the flow field between the inlet and the outlet, the liquid/gas diffusion layer having a solid substrate through which a plurality of pores is formed. The disclosed bipolar plate flow field and liquid/gas diffusion layer could work together or separately with other types of porous transport layers or bipolar plates to enhance the water/gas transport. In these configurations, the lands can be arranged and configured such that the plurality of pores are substantially unobstructed by the lands.

### CROSS-REFERENCE TO RELATED APPLICATIONS

This application is a divisional of U.S. patent application Ser. No. 17/717,821, filed Apr. 11, 2022; which claims the benefit of U.S. Provisional Patent Application Ser. No. 63/233,531, filed Aug. 16, 2021, the disclosure of each of which is incorporated herein by reference in its entirety.

### GOVERNMENT INTEREST

This invention was made with government support under Grant Nos. EE0008426 and EE0008423 awarded by the Department of Energy. The government has certain rights in the invention.

### TECHNICAL FIELD

The subject matter disclosed herein relates generally to solid polymer electrolyte electrolyzers, fuel cells, unitized regenerative fuel cells (URFCs), and other electrochemical cells. More particularly, the subject matter disclosed herein relates to the design and construction of a bipolar plate flow field and porous transport layer of such devices.

### BACKGROUND

As society and technologies change, the U.S. energy system is evolving from traditional fossil energy towards sustainable, affordable, and reliable energy sources. In this regard, water electrolysis based on the low-temperature solid polymer electrolyte membrane electrolyzer cells (PEMECs) is one of the most competitive hydrogen production candidates because PEMECs can be combined with intermittent renewable energy sources (e.g., geothermal, wind, solar, hydroelectricity) to realize carbon-free and high-purity hydrogen production.

PEMECs were typically constructed in a sandwich configuration, including end plates, current collectors, bipolar plates (BPs), porous transport layers (PTLs), and catalyst layers for both anode and cathode sides, as well as a solid polymer electrolyte membrane (PEM) serving as the electrolyte. PTLs play many roles in PEMECs, including electricity transfer, mass transfer, heat transfer and mechanical support, indicating the significance of the impact of PTLs' properties on the overall performance of PEMECs. According to the configuration of conventional PTLs, it can be divided into felt, mesh, foam and sintered powder plates. However, for the conventional PTLs, the pileup of microfibers or particles leads to large contact resistance and requires large thickness to ensure mechanical strength. To decrease the contact resistance and the material cost, thin/tunable liquid/gas diffusion layer (TTLGDL) can be used as a PTL, which can decrease the ohmic resistance and the PTL's thickness.

In addition, though, for both conventional PTLs and TTLGDLs, the transport of reactants/products relies on the existence of micropores inside PTLs or TTLGDLs. Due to the properties of flow fields and the sandwich structure of PEMECs, however, the micropores in PTLs or TTLGDLs are often blocked by the lands of the BP flow field, resulting in the impediment of reactant/product transport under the solid land area. In fact, it has been shown that gas accumulation under the land area is much larger than under the channel area. The excess gas accumulation under the land area can cause severe ohmic and mass transport issues and degrade the overall performance of PEMECs, especially under high current density. In some cases, mass transport limitations can be alleviated with increased water pumping rate, but such a solution presents a parasitic loss, decreasing overall system efficiency and ultimately increasing the cost of hydrogen production. Accordingly, it would be desirable to overcome the severe mass transport challenges under the land area of the BP flow field in such systems.

### SUMMARY

In accordance with this disclosure, devices, systems, and methods of producing improved fluid flow assemblies in solid polymer electrolyte electrolyzers, fuel cells, and unitized regenerative fuel cells are provided. In one aspect, a fluid flow assembly for a solid polymer electrolyte electrochemical cell is provided. The fluid flow assembly includes a bipolar plate (BP) flow field comprising an inlet, an outlet, and a plurality of discrete lands arranged within the flow field; and a liquid/gas diffusion layer positioned in fluid communication with the flow field between the inlet and the outlet, the liquid/gas diffusion layer comprising a solid substrate through which a plurality of pores is formed. In this arrangement, the BP lands can be arranged and configured such that the plurality of pores is substantially unobstructed by the BP lands.

In another aspect, a method for fabricating a fluid flow assembly porous transport layer for a solid polymer electrolyte electrochemical cell is provided. The method includes steps of positioning a plurality of discrete lands between an inlet and an outlet to define a bipolar plate flow field, and positioning a porous transport layer in fluid communication with the flow field between the inlet and the outlet. Specifically, positioning the porous transport layer can include arranging and configuring the BP lands such that the plurality of pores is substantially unobstructed by the BP lands.

In another aspect, a flow-enhanced liquid/gas diffusion layer design includes a solid substrate through which a plurality of pores is formed. This design introduces additional micro channels in the liquid/gas diffusion layers for improving its in-plane and through-plane transport ability. The configuration of micro channels could be parallel, wedge-shaped, or crossed, or their combinations. The amount, length, width, height, wedge angles, and crossed directions of micro channels are well-tunable, depending on the specific system design. The configuration of the micro channels could also include modifying the cross-section of the channels. The cross-section design can be inverted trapezoidal, where parameters of top width, bottom width, and height of channels are well-tunable. Specifically, the micro channels can be partially fabricated in coupling the lands of the bipolar plate flow field. Positioning the liquid/gas diffusion layer can include arranging and configuring the lands of bipolar plate flow field. In this arrangement, the water and gas transport are enhanced in both in-plane and through-plane directions and substantially unobstructed by the lands.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a plan view of a pin type flow-field according to an embodiment of the presently disclosed subject matter.

FIG. 2 is a perspective side view of a design for a pin type flow-field with combined micro-patterned LGDL into a unitized component according to an embodiment of the presently disclosed subject matter.

FIG. 3 is a graph showing a performance comparison between pin-type flow-field and conventional, parallel flow-field using a micro-patterned LGDL with 200 μm pores in diameter.

FIGS. 4A and 4B are graphs showing current distribution maps and mass transport number (MTN) distributions (at 2.3 V and 6 mL/min) on a parallel flow-field and a pin-type flow-field, respectively.

FIGS. 5A through 5C are side perspective views of porous transport layers of a PEMEC according to a conventional titanium felt configuration, a thin/tunable LGDL configuration, and a flow-enhanced LGDL configuration, respectively.

FIGS. 6A and 6B are graphs showing polarization curves of PEMECs using a conventional PTL/CCM design and a CCLGDL/PEM design, respectively.

FIG. 7 is a graph showing anode catalyst mass activity of different designs under the voltage of 1.8 V.

FIGS. 8A through 8C are various views of a wedge-shaped micro channel design according to embodiments of the presently disclosed subject matter.

FIGS. 8D through 8G are side views of various multi-directional channel designs according to embodiments of the presently disclosed subject matter.

FIGS. 9A and 9B are a side perspective view and a side cutaway view in a through-plane direction, respectively, of a micro channel design with a wedge-shaped cross-section according to embodiments of the presently disclosed subject matter.

FIGS. 10A and 10B are images showing a comparison between an un-modified thin/tunable liquid/gas diffusion layer and a similar structure to which a nitride surface modification has been applied according to an embodiment of the presently disclosed subject matter.

FIG. 10C is a series of images showing a surface composition analysis from an energy-dispersive X-ray spectroscopy (EDX) spectrum analysis for a liquid/gas diffusion layer according to an embodiment of the presently disclosed subject matter.

FIG. 11 is a graph illustrating cell performance of thin/well-tunable liquid/gas diffusion layers (TTLGDLs) with and without a titanium nitride (TiNₓ) coating layer according to embodiments of the presently disclosed subject matter.

### DETAILED DESCRIPTION

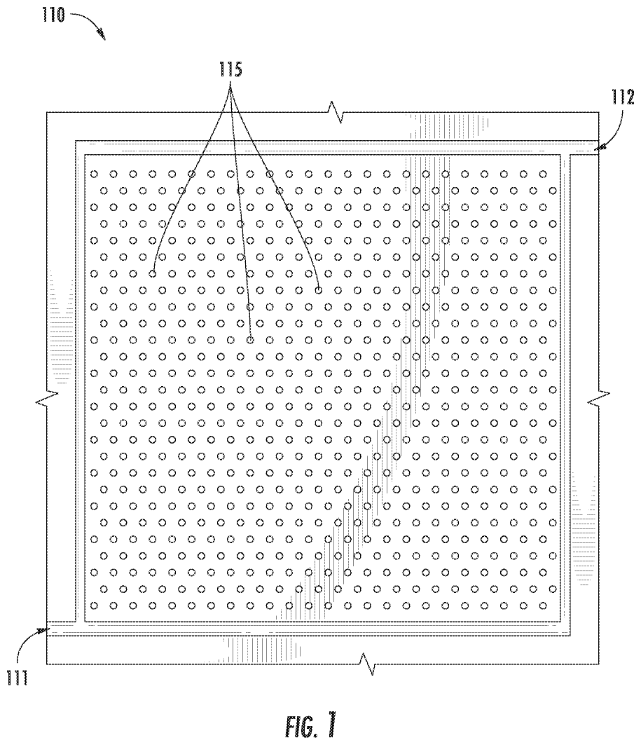

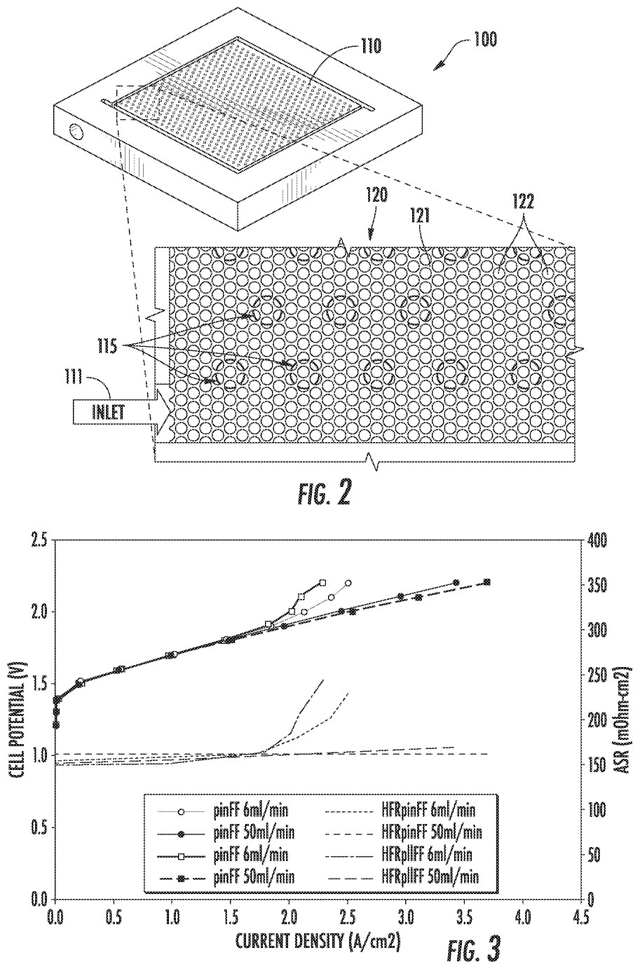

The present subject matter provides devices, systems, and methods of producing improved porous transport layers in solid polymer electrolyte electrolyzers, fuel cells, and unitized regenerative fuel cells. In one aspect, the present subject matter provides a flow field that maximizes mass transport in PEMECs, achieving excellent electrochemical activity without the need for high water pumping rate. Referring to FIGS. 1 and 2, a combination of a bipolar plate flow field 110 and a porous transport layer (PTL) 120 serves as fluid flow assembly, generally designated 100.

In this configuration, the flow field 110 is a pin-type flow field that is configured to provide fluid flow between an inlet 111 and an outlet 112, and a plurality of discrete lands 115 is arranged within the flow field 110 to distribute the fluid flow substantially uniformly through a plurality of flow channels 116 across the flow field 110. In some embodiments, the lands 115 are configured as substantially circular contact pillars. Alternatively, the flow field 110 can have any of a variety of configurations, including but not limited to a parallel flow field, a single serpentine flow field, a multiple serpentine flow field, an interdigitated flow field, and a cascade flow field. Regardless of the particular configuration, in some embodiments, the lands 115 can be arranged in a substantially staggered pattern that is configured to reduce large pressure drops and promote exchange in-between the flow channels 116.

In some embodiments, the PTL 120 of the PEMEC is positioned in fluid communication with the flow field 110 between the inlet 111 and the outlet 112. In some embodiments, the PTL 120 is a liquid/gas diffusion layer (LGDL) that is formed from a solid substrate 121 through which a plurality of pores 122 are formed. In this arrangement, the flow field 110 provides a desired supply of reactants to interior layers of the PEMEC through the pores 122 of the PTL 120. In combination with this structure, the architecture of the flowfield 110 alleviates mass transport limitations because it addresses the lack of in-plane permeability of some PTLs, such as LGDLs.

In this regard, in some embodiments, ohmic losses can be reduced by constructing the flow field 110 and PTL 120 as a unitized component, and obstruction within the membrane and between the flow field 110 and PTL 120 can be reduced by configuring the flow field 110 to be substantially aligned with non-porous regions of the PTL 120. For example, in some embodiments, the pin design, pitch, and aspect-ratios of the flow field 110 can be adjusted to maximize porosity for a given configuration of the PTL 120, such as is shown in FIG. 2. In this regard, the design of one or both of the flow field 110 or the PTL 120 can be configured to optimize for a desired balance between reduced fluid resistance (e.g., by using fewer pillars/lands 115) and enhanced electronic contact (e.g., by including more pillars/lands 115). When using an LGDL as the PTL 120, the size, placement, and density of pin-style lands 115 can be tailored to any particular LGDL structure.

In some embodiments, for example, each of the lands 115 of the flow field 110 is substantially aligned with portions of the substrate 121 between the pores 122 such that the plurality of pores 122 are substantially unobstructed by the lands 115 for a given configuration of the PTL 120. Such coordinated design of the components can enable superior electrochemical performance. In comparison to conventional parallel or serpentine flow field designs, which can obstruct a substantial portion of the underlying PTL 120 (e.g., with a porosity of 0.5 or less), a pin-type flow field 110 can be configured to align with the underlying PTL 120 so that the effective porosity is optimized (e.g., greater than about 0.88).

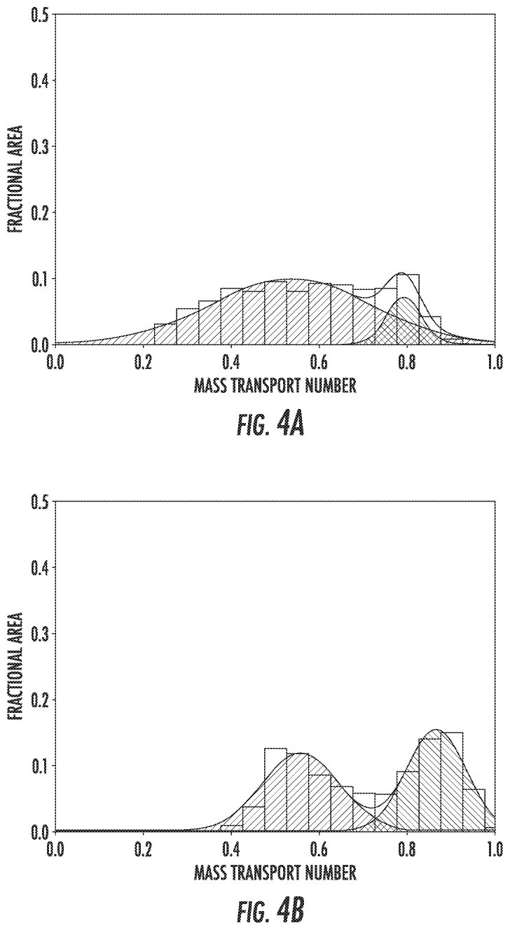

In a representative, non-limiting example, a pin type flow-field was fabricated and tested with a micro-patterned LGDL with 200 μm pores in diameter and catalyst-coated LGDL (CCLGDL) at standard operating conditions. FIG. 3 shows the polarization data comparing the performance of the pin-type with a conventional parallel flow-field for flow-rates of 6 mL/min and 50 mL/min, with the pin-type flow-field outperforming the parallel flow-field at low and high flow-rates. Furthermore, the HFR at the lowest flow-rate is considerably lower for the pin-type flow-field when compared to the parallel flow-field, indicating that the design can assist with effective bubble removal and reduce local membrane dry-out. In addition, those having ordinary skill in the art will appreciate that a pin-type flow-field of this kind can provide improved performance for other forms of PTLs, including but not limited to metal-based or carbon-based powder plates, papers, felts, cloths, sintered powders, foams, expanded meshes, and woven meshes. Representative metals include but are not limited to titanium, nickel, stainless steel, and niobium. Thus, benefits to both mass transport and reduced ohmic loss can be achieved. In addition, parasitic pumping losses are reduced, and the capital cost for larger pumps can be mitigated by sizing smaller pumps.

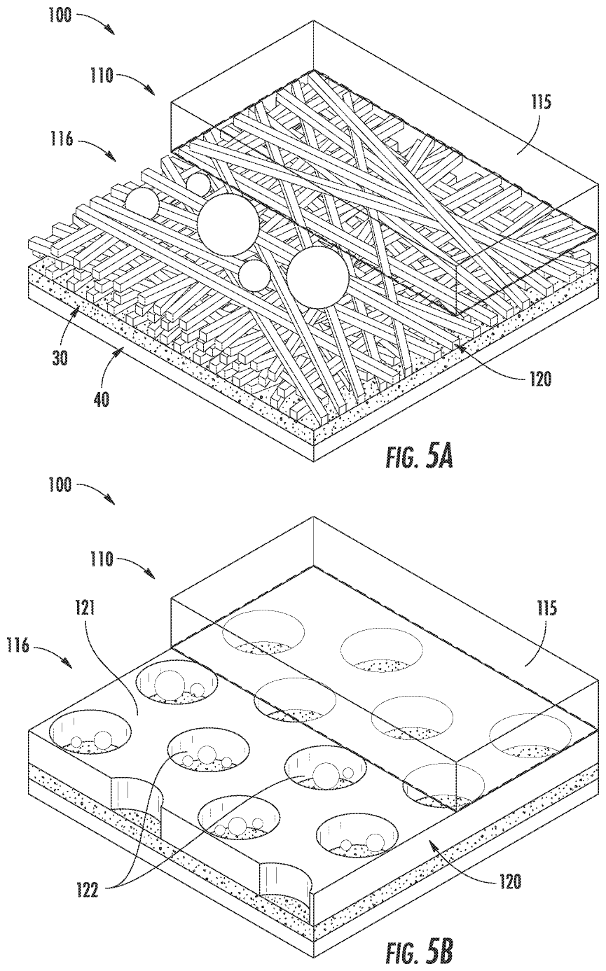

FIGS. 4A and 4B show the local mass transport number (MTN) distribution for the parallel and pin type flow-fields, respectively. The MTN indicates uniformity of current density in an operating polymer electrolyte water electrolyzer and is inversely proportional to mass transport limitation. Comparing the distributions, it is evident that the pin-type flow-field can provide better area utilization (e.g., MTN of 0.5 or higher in 80% of its active area compared to the parallel flow-field that sustained a MTN greater than 0.5 in only about 50% of active area). The experimental results for the pin flow-field showed a consistent 2-15% improvement in current density at 2.3V across a range of flow rates and for two different LGDLs. Table 1 summarizes the performance gains achieved using this new flow-field design.

TABLE 1
Comparison of pin and parallel flow fields for 8c4
and 8c4 CCLGDL PEMECs.

| | Current density (A/cm²) | | | Current density (A/cm²) | | |
|---|---|---|---|---|---|---|
| Diffusion | @ 2.0 V | | | @ 2.3 V | | |
| Media | Parallel | Pin | % gain | Parallel | Pin | % gain |
| 8c4 | 2.52 | 2.58 | 2.34 | 4.13 | 4.32 | 4.45 |
| 8c4 CCLGDL | 1.71 | 1.86 | 8.83 | 2.73 | 3.15 | 15.3 |

The 8c4 CCLGDL was geometrically identical to a micro-patterned LGDL with 200 μm pores in diameter but was meanwhile catalyst-coated. The additional catalyst loading on the CCLGDL enhanced sensitivity to the mass transport improvement made possible by the pin-type flow-field. This representative embodiment shows that substantial benefit can be realized for bare LGDL and CCLGDL constructions. In addition, a unitized pin-type flow field/LGDL combination can further reduce ohmic losses, yielding even better electrochemical performance and efficiency in polymer electrolyte water electrolyzers.

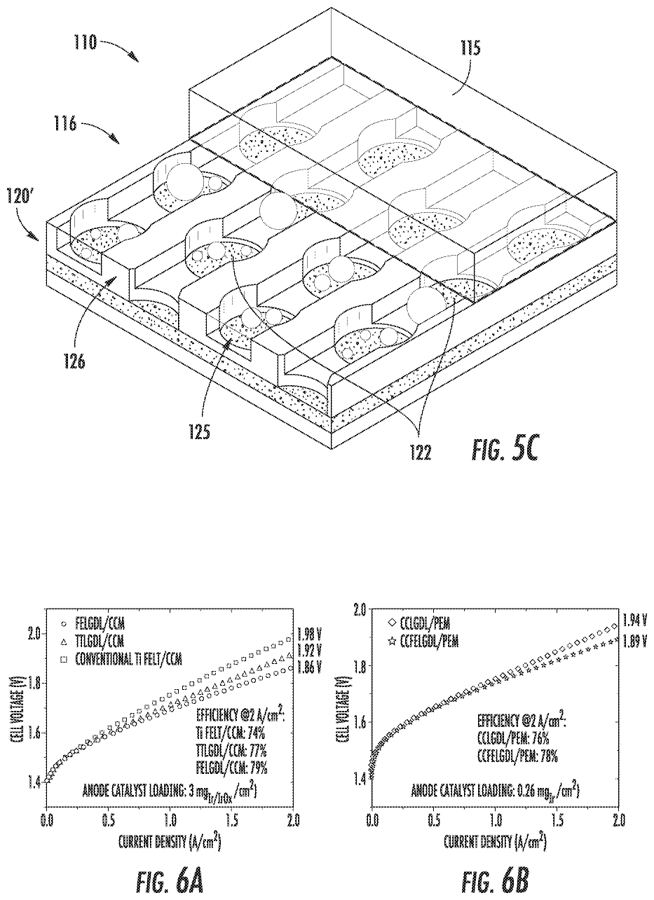

The configuration of the PTL 120 can further be designed to improve the mass transport, performance, and efficiency in electrolyzers and fuel cells. Referring to FIG. 5A, the PTL 120 is a conventional titanium felt PTL that is compressed from microfibers to form a random porous structure, serving as gas/water transport pathway between the BP flow field 110 and a catalyst layer 30 and solid polymer electrolyte membrane 40. By comparison, as shown in FIG. 5B, a uniform-thickness LGDL serving as the PTL 120 has a substantially planar surface, a thinner thickness (e.g., about 25, 50, 75, 100, 125, 150, 175, or 200 μm, or having any of a range of values therebetween them), and the plurality of pores 122 arranged effectively straight through the thickness. The PTL 120 can be composed of any of a variety of materials, including but not limited to metals (e.g., titanium, nickel, stainless steel, or niobium), graphite, alloys, or composites. Although such an arrangement for the PTL 120 can decrease the material cost and also decrease the ohmic and transport losses to achieve superior performances, some of the pores 122 can be obstructed by the BP lands 115.

As shown in FIG. 5C, however, in some embodiments, a flow-enhanced configuration of the LGDL (FELGDL), generally designated 120′, can be modified to include a plurality of micro channels 125 that are configured to provide in-plane transport in LGDLs via connecting the pores 122. In some embodiments, the micro channels 125 can be depressed into the surface of the FELGDL 120′ to connect two or more of the pores 122. Alternatively, in some embodiments, the FELGDL 120′ can be a multi-layer structure in which one layer is configured to include the pores 122, and a further layer is configured to include the micro channels 125. In some embodiments, the micro channels 125 are included across substantially an entire surface of the FELGDL 120′ to provide enhanced in-plane transport over the entire surface. Alternatively, in some embodiments, the micro channels 125 are included across only a portion of a surface of the FELGDL 120′ to provide in-plane transport in selected areas of the FELGDL 120′ (e.g., in areas that are at least partially obstructed, such as by BP lands 115).

Depending on the desired distribution of fluid flow to the pores 122, the micro channels 125 can be arranged in a common direction, or the channels 125 can be arranged in different directions. Further, the length of each of the micro channels 125 can extend a distance sufficient to connect two pores or multiple pores in succession. In some embodiments, the micro channels 125 are sized to have a width that is substantially equal to a width of the pores 122 with which they are aligned. Alternatively, the width can be smaller or larger than the width of the pores 122. In any configuration, even though the lands 115 of the BP flow field 110 remain in contact with a surface of the FELGDL 120′, the micro channels 125 provide selective fluid flow beneath portions of the obstructed surface so that the active areas in each of the pores 122 are “open” to the reactions. As a result, the gas accumulation and pore blockage in un-modified LGDL configurations can be avoided to a great extent. The in-plane micro channels 125 can thus enhance the reactant/production transport of the whole active area including in areas corresponding to both the lands 115 and the flow channels 116 at the same time.

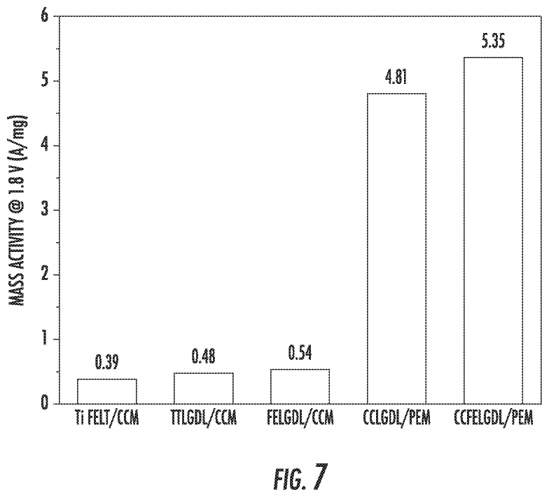

Such a configuration for the FELGDL 120′ can further improve the operation of the polymer electrolyte water electrolyzer in which it is included. For example, in conventional systems, catalyst layers are coated on the PEM, and form catalyst-coated membranes (CCMs). By using the FELGDL 120′ as a PTL for such a system, improved performance can be achieved. Specifically, in one experimental configuration, a PTLs/CCM using anode catalysts having 3.0 mg Ir/cm², the presently disclosed FELGDL can achieve a cell voltage of 1.86 V at the current density of 2 A/cm². As shown in FIG. 6A, compared to a titanium felt cell and TTLGDL cell, a 120 mV and 60 mV cell voltage decrease can be achieved, respectively. In addition, under a current density of 2 A/cm², the efficiencies of titanium felt cell and TTLGDL are about 74% and 77%, respectively, whereas the FELGDL cell exhibits the highest efficiency of 79%.

Alternatively, in place of a conventional PTL/CCM configuration, there has been development in catalyst-coated liquid/gas diffusion layers (CCLGDLs) to promote improved catalyst utilization and PEMEC efficiency. Using the FELGDL 120′ in such a configuration can likewise provide improved performance. For example, in a CCLGDLs/PEM using anode catalysts having 0.26 mg Ir/cm², test results are shown in FIG. 6B. The catalyst-coated FELGDL (CCFELGDL) has a cell voltage of 1.89 V at the current density of 2 A/cm², about 50 mV lower than the normal CCLGDL (1.94 V at the current density of 2 A/cm²). Under the current density of 2 A/cm², the efficiency also increased from 76% to 78% by replacing a standard CCLGDL with the CCFELGDL.

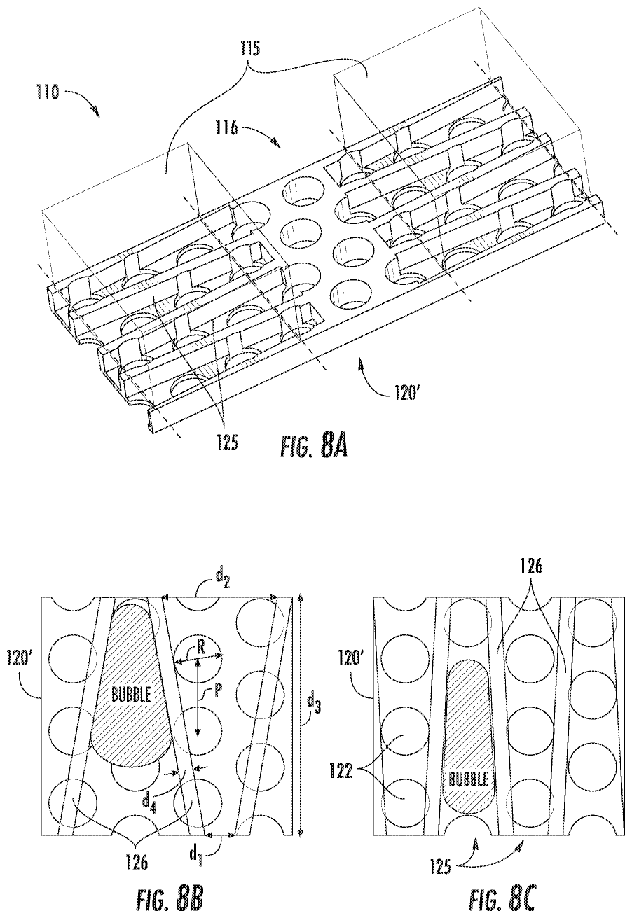

FIG. 7 shows the mass activities of different designs under the voltage of 1.8 V. For the PTLs/CCM design, the FELGDL cell achieved the highest mass activity of 0.54 A/mg, while the one for TTLGDL cell and titanium felt cell is 0.48 A/mg and 0.39 A/mg, respectively. The higher mass activity of FELGDL cell proves that the FELGDL could increase the catalyst activation about 38% compared with the titanium felt. For the CCLGDLs/PEM design, CCFELGDLs also increased the cell mass activity from 4.81 A/mg to 5.85 A/mg. The enhancement of mass activity proves that the architecture of the FELGDL can enhance the catalyst activation in both PTLs/CCM design and CCLGDLs/PEM design. The experimental data thus provides clear support for the superior performance of the FELGDL in a variety of configurations of PEMECs. The increased cell performance, efficiency, and catalyst mass activity can reduce not only the capital cost, but also the operation cost of PEMECs, thus promoting the large-scale application of hydrogen energy.

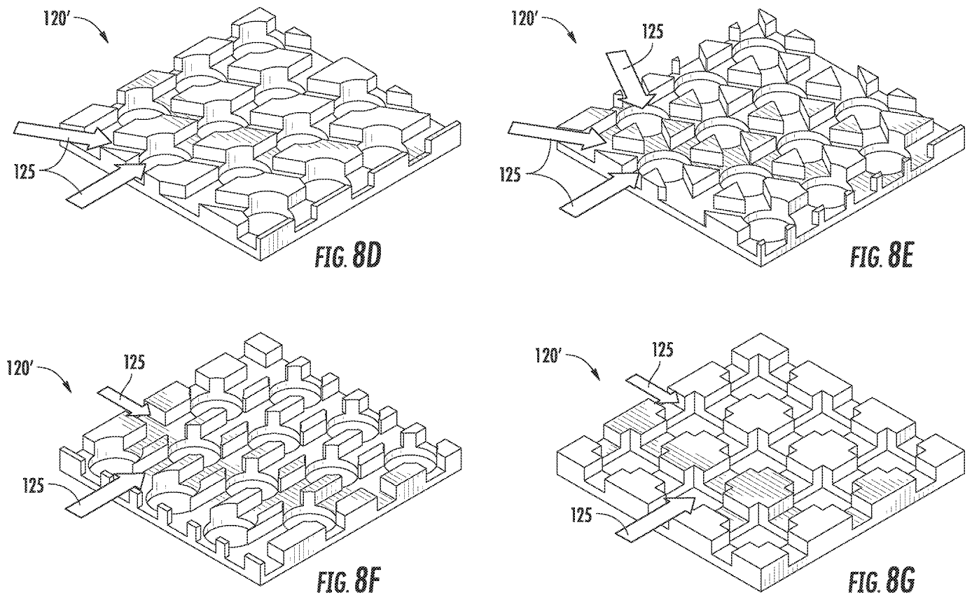

In some embodiments, the performance of the FELGDL 120′ can further be enhanced by modifying the configuration of the micro channels 125. As shown in FIG. 8A through 8C, the arrangement of the micro channels 125 can be configured to create wedge-shaped flow channels with one end of each of the micro channels 125 being wider than an opposing end. By this design, bubbles generated in the micro channels 125 can grow and form a correspondingly wedge-like shape, which can help bubble release and promote multiphase transport.

In some embodiments, this wedge-shaped configuration of the micro channels 125 is selectively provided only in regions of the FELGDL 120′ that are positioned beneath the lands 115 of the flow field 110, which are those areas in which flow enhancement is most desired as shown in FIG. 8A. In contrast, in some embodiments, in regions aligned with the open flow channels 116 of the flow field 110, the micro channels 125 can be omitted, which can avoid increases in the fabrication cost and time. The dimension ratio of channel area and non-channel area can be adjusted according to the configuration of lands 115 and flow channels 116 to make sure that all the lands 115 are arranged in registry with areas having the flow-enhancing micro channels 125 on the FELGDL 120′. In some embodiments, for example, the lengths of the micro channels 125 can be configured to be larger than the width of the BP lands 115 to provide space to facilitate gas release.

The wedge angle of the flow-enhancing micro channels 125 is well-tunable. FIGS. 8B and 8C illustrate two configurations of the FELGDL 120′ with different angles for the wedge-shaped micro channels 125. The passive moving of wedge-shaped bubble is driven by the capillary pressure difference of the narrow side and the wide side (e.g., the capillary pressure can change with the bubble surface radius nonlinearly), which means that the magnitude of driven force will change with the movement of the wedge-shaped bubbles. In some embodiments, to maintain the relatively large driving force in the wedge-shaped channels, the wedge angle of channels can be optimized with the land width of the BP flow field 110. In some embodiments, for example, one or more of a length, a width, and a spacing of the micro channels 125 can be configured to be large enough to maintain a large wedge angle and small enough to maintain the uniformity of clamping pressure and strength of the FELGDL 120′, which can be optimized via experimental and/or theoretical investigation. Based on LGDL pore patterns, the walls 126 of one or more of the micro channels 125 may cross some of the pores 122, although such a configuration can have a minimal impact on transport or in the fabrication processes.

As shown in FIG. 8B, the configuration of micro channels 125 can be characterized by a combination of a channel lower width d₁ (e.g., between about 0 to 200 μm), a channel upper width d₂ that is equal to or greater than the channel lower width d₁, a channel length d₃, a channel wall thickness d₄ (e.g., between about 25 to 300 μm), and a channel depth h. In some embodiments, the channel length dₐ is configured to be longer than a width of the lands 115. For a constant value of the channel depth h, the ratio between the upper width d₂ and the lower width d₁ determines the wedge angle. For example, where the lower width d₁ is equivalent to the upper width d₂, the channel shape can be characterized as being substantially rectangular (e.g., having a substantially constant width along one or both of a length or a depth of the micro channel). In another configuration, the lower width d₁ is close to or equal to 0, which produces a channel shape that is substantially triangular. The particular channel shape can thus be designed by selecting the values for these parameters based on the given configuration of the fluid flow assembly 100, which can in some embodiments include consideration of the surface roughness of the PTL 120/FELGDL 120′, width of the BP lands 115, and operating conditions of the system. In some embodiments, the parameters can be selected such that bubbles will accelerate first and slow down after reaching the highest speed. For example, where the wedge angle is configured to substantially match the width of the flow field lands 115, the bubbles can reach around the highest speed at or near the outlet of the wedge-shaped micro channels 125.

As shown in FIGS. 8D through 8G, the FELGDL 120′ can also have configurations with crossed multi-directional channels. In some embodiments, the channels can be arranged in two directions. The angle between the two directions can be well-tunable. In some embodiments, the angle can be in a range between about 90° and about 120°. The configuration of the multi-directional channels is not limited in the use of LGDL 120 with hexagonal pore distributions. In some embodiments, FELGDL 120′ with orthogonal pore distributions also adopts multi-directional channel configuration.

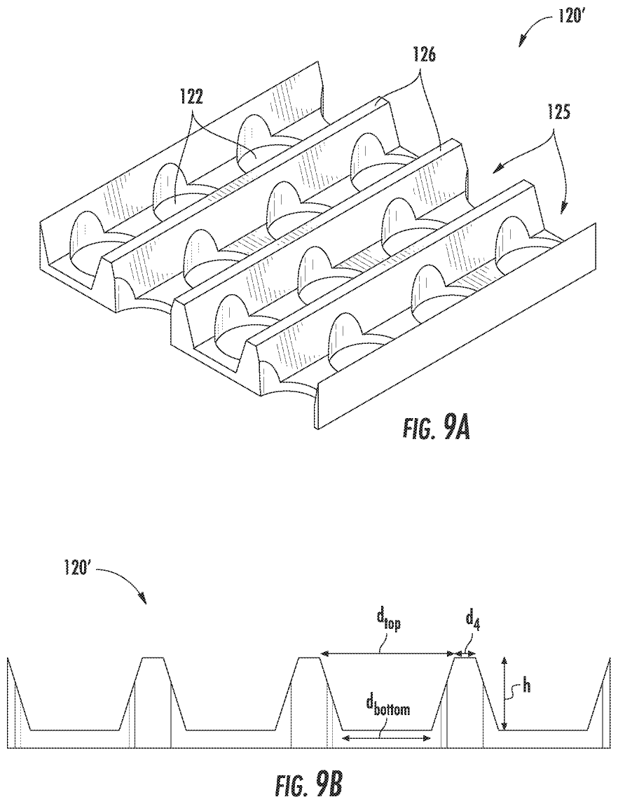

Alternatively, or in addition, referring to FIGS. 9A and 9B, in some embodiments, the cross-sectional geometry design of the micro channels 125 can be adjusted to enhance the through-plane bubble release. In some embodiments, the micro channels 125 are designed to have a substantially inverted trapezoidal cross-sectional shape, wherein a lower width d_{bottom} (e.g., having a width between about 25 to 200 μm) is narrower than an upper width dₜₒₚ. In some embodiments, the depth h of the micro channels 125 can be adjusted, wherein a deeper channel may allow bubbles more time to release before they occupy the reaction sites in the LGDL and catalyst and PEM interface. In some embodiments, with the determinate FELGDL thickness and ratio of upper width dₜₒₚ/lower width d_{bottom}, the depth h can be designed such that the bottom of the FELGDL 120′ has a thickness of at least about 25 μm to maintain a desirable mechanical strength. At the same time, the channel wall thickness d₄ can be designed to have a width of at least about 25 μm to maintain a reasonable strength in the contact surface of the BP flow field 110 and the FELGDL 120′.

Those having ordinary skill in the art will recognize that any of a variety of other adjustments of these parameters, either individually or in combinations together, can be made to correspondingly adjust the operation of the FELGDL 120′ according to the specific requirements of the fluid flow assembly 100.

Regardless of the particular structural configuration of the PTL 120/FELGDL 120′, in some embodiments, the material of the substrate can be modified to improve performance of the fluid flow assembly 100. In some embodiments, modification of the substrate can involve providing a surface coating on the PTL 120/FELGDL 120′, the surface coating comprising a material including but not limited to a nitride, a metal, a carbide, a composite, or any combination thereof. In addition, in some embodiments, the surface coating can be applied by any of a variety of processes, including but not limited to galvanizing, electrochemical coating, chemical vapor deposition, physical vapor deposition, conversion coating, thermal spraying, chemosynthesis, or any combination thereof.

In some particular embodiments, for example, modification of the substrate can involve nitridation on the substrate for nitride formation, which can be used to meet requirements of corrosion resistance that are sufficient to withstand the chemical and electrochemical corrosions from acidic/basic atmosphere and high voltage during cell operation, respectively. In some particular embodiments, for example, where a titanium-based substrate is used as the PTL 120/FELGDL 120′, modification of the substrate can involve nitridation on the titanium substrate for titanium nitride (TiNₓ) formation, where x is a value in a range of 0<x≤5.0. For example, x can be 0.3, 0.5, 2, 5 or any other value falling within this range, depending on the nitridation levels. In some embodiments, such a nitridation process is carried out under ammonia at any of a range of temperatures between about 600° C. and about 1000° C., including 600° C., 700° C., 800° C., 900° C., or 1,000° C. The nitride coating thickness can be dependent on the nitridation temperature and time, where a higher applied temperature and longer time can result in a thicker coating. For example, at 800° C., the TiNₓ coating thickness can be about 120 nm, which is sufficient to increase the electrical conductivity. Moreover, TiNₓ can provide further benefits of high electrical conductivity and excellent resistance to most chemicals, and is reported as an effective electronic structure modulator, which meets all the expectations for a promising substrate for catalysts used on an anode structure to facilitate the oxygen evolution reaction (OER).

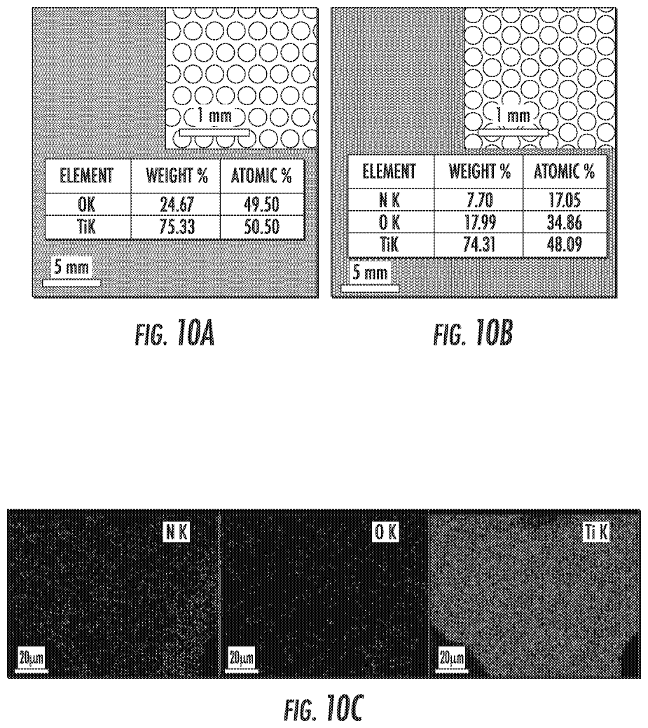

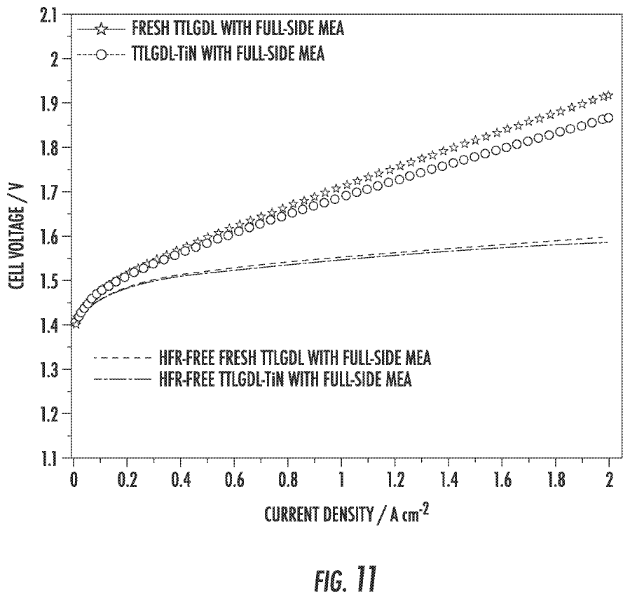

In one example embodiment, the PTL 120/FELGDL 120′ is a thin/well-tunable liquid/gas diffusion layer (TTLGDL) that is fabricated from thin titanium foils with engineered thickness (e.g., ranging from about 25 to about 200 μm, including about 25, 30, 35, 40, 45, 50, 55, 60, 65, 70, 75, 80, 85, 90, 95, 100, or 200 μm), pore shape (e.g., triangle, square, pentagon, hexagon, octagon, decagon, or combinations thereof), pore size (e.g., having a hydraulic diameter ranging from about 50 to about 400 μm, including about 50, 100, 150, 200, 250, 300, 350, or 400 μm), and porosity (e.g., ranging from about 20% to about 70%, including about 20, 30, 35, 40, 45, 50, 55, 60, 65, or 70%). As shown in FIGS. 10A and 10B, it can be observed that a sample color change from a silvery white color into a golden yellow color indicates the formation of TiNₓ on the surface. The element mapping from energy-dispersive X-ray spectroscopy (EDX) spectrum analysis as shown in FIG. 10C indicates that the formed nitrides are uniformly distributed on the substrate surface. FIG. 11 shows a comparison of the performance between TiNₓ-coated TTLGDL and un-modified TTLGDL in the water electrolyzer cells coupled with full side MEA. The TTLGDL-TiNₓ can achieve 52-mV improvement at 2 A/cm², the significant enhancement of which can be ascribed to the benefit that the low conductivity resistance of the LGDL through the surface nitriding and/or oxide removal, such as by using an oxalic acid surface treatment.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The presently disclosed subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. A fluid flow assembly for a solid polymer electrolyte electrochemical cell comprising:
a bipolar plate flow field comprising an inlet, and outlet, and a plurality of discrete lands arranged within the flow field; and
a liquid/gas diffusion layer positioned in fluid communication with the flow field between the inlet and the outlet, the liquid/gas diffusion layer comprising a solid substrate through which a plurality of pores is formed;
wherein the lands are arranged and configured such that the plurality of pores is substantially unobstructed by the lands.

2. The fluid flow assembly of claim 1, wherein the lands are substantially aligned with non-porous regions of the solid substrate.

3. The fluid flow assembly of claim 1, wherein the liquid/gas diffusion layer comprises a plurality of micro channels formed in a surface of the liquid/gas diffusion layer that faces the flow field, wherein the plurality of pores is arranged within the plurality of micro channels.

4. The fluid flow assembly of claim 3, wherein the plurality of micro channels is formed on a surface of the liquid/gas diffusion layer in portions of the liquid/gas diffusion layer that are aligned with the lands of the flow field.

5. The fluid flow assembly of claim 3, wherein one or more micro channel of the plurality of micro channels has a width that varies along a length of the micro channel.

6. The fluid flow assembly of claim 3, wherein one or more micro channel of the plurality of micro channels has a width that varies with a depth of the micro channel.

7. The fluid flow assembly of claim 3, wherein the plurality of micro channels are arranged in multiple different directions to form a micro channel mesh on the liquid/gas diffusion layers.

8. The fluid flow assembly of claim 1, wherein the liquid/gas diffusion layer comprises one or more layer having a surface coating selected from the group consisting of a metal, a nitride, a carbide, a composite, and combinations thereof.

9. A method for fabricating a fluid flow assembly for a solid polymer electrolyte electrochemical cell, the method comprising:
positioning a plurality of discrete lands between an inlet and an outlet to define a bipolar plate flow field; and
positioning a porous transport layer in fluid communication with the flow field between the inlet and the outlet;
wherein positioning the porous transport layer comprises arranging and configuring the lands such that the plurality of pores is substantially unobstructed by the lands.

10. The method of claim 9, wherein the lands are substantially aligned with non-porous regions of the solid substrate.

11. The method of claim 9, comprising forming a plurality of micro channels in a surface of the liquid/gas diffusion layer that faces the flow field, wherein the plurality of pores are arranged within the plurality of micro channels.

12. The method of claim 11, wherein the plurality of micro channels are formed in a surface of the liquid/gas diffusion layer in portions of the liquid/gas diffusion layer that are aligned with the lands of the flow field.

13. The method of claim 11, wherein each micro channel of the plurality of micro channels has a width that varies along a length of the micro channel.

14. The method of claim 11, wherein each micro channel of the plurality of micro channels has a width that varies along a depth of the micro channel.

15. The method of claim 9, wherein the liquid/gas diffusion layer comprises one or more layer having a nitride surface coating.

16. The method of claim 9, wherein the porous transport layer comprises a material selected from the group consisting of a metal sintered powder plate, a metal felt, a metal woven mesh, a metal foam, a carbon paper, a carbon felt, a carbon cloth, and a carbon foam.

17. The method of claim 9, wherein the flow field of bipolar plate comprises a configuration selected from the group consisting of a pin-type flow field, a parallel flow field, a single serpentine flow field, a multiple serpentine flow field, an interdigitated flow field, and a cascade flow field.

18.-25. (canceled)
